(19) United States
(12) Patent Application Publication
(10) Pub. No.: US 2016/0217430 A1
(43) Pub. Date: Jul. 28, 2016

(54) APPOINTMENT SCHEDULING SYSTEM BASED ON LOOSELY COUPLED OWNERSHIP

(71) Applicant: TimeTrade Systems, Inc., Tewksbury, MA (US)

(72) Inventor: John Loring, Tewksbury, MA (US)

(21) Appl. No.: 14/995,274

(22) Filed: Jan. 14, 2016

Related U.S. Application Data
(60) Provisional application No. 62/106,401, filed on Jan. 22, 2015.

(51) Int. Cl. G06Q 10/10

(52) U.S. Cl. CPC G06Q 10/1095

(57) ABSTRACT

An appointment booking and fulfillment computing system which calculates available times based on a set of virtual scheduling resources, loosely coupled to a set of actual fulfillment (physical) resources which own the appointment during its fulfillment lifecycle. A user-configurable rules engine implemented in the system logic controls how these two sets of resources impinge on each other.

### PRIORITY CLAIM

This application claims priority to U.S. Provisional Application No. 62/106,401, filed Jan. 22, 2015, the entirety of which is incorporated herein by reference.

### BACKGROUND

Current appointment scheduling systems allow scheduling based upon the availability and capacity of the actual people that will service the appointment, based upon a projection of that capacity completed many months in advance. There are several factors which can affect the relationship between a set of resources and their associated appointments which may change between the time the appointment is booked and when it occurs.

Since appointments can be scheduled many months in advance, some of the scheduled resources may no longer be available, either permanently or temporarily, on the date of the appointment. Appointments adjacent to any specific scheduled appointment may run longer than their allocated times, causing assigned resources to be temporarily unavailable whereas other suitable resources are available. Information collected from a client when checking-in for an appointment may suggest that a different resource than originally assigned would be more appropriate.

There may be a need to balance utilization across all resources available during any given day, but there is limited support for this dynamic reallocation in existing systems. Where it is possible to transfer appointments among servicing resources on an ad hoc basis, there is no audit trail of these sequential assignments. Scheduled appointment volume is determined by actual scheduled resources. There is very limited capability to determine the optimum number of resources based on achievable appointment volume.

### SUMMARY

Presented herein is a system and methods that allow for maximizing a flow of appointments into a business based on a desired appointment volume rather than on a fixed set of physical resources predefined for a time period.

### BRIEF DESCRIPTION OF THE DRAWINGS

FIG. 1 is a system block diagram according to an example embodiment.

FIGS. 2 and 3 are flow charts depicting operational flows according to an example embodiment.

FIGS. 4A-4F are screen shots of user interface screens, according to example embodiments.

FIG. 5 is a flow chart depicting overall operational flow, according to an example embodiment.

FIG. 6 is a block diagram of one or more of the entities shown in FIG. 1, according to an example embodiment.

### DESCRIPTION OF EXAMPLE EMBODIMENTS

Presented herein are a system and methods that allow for maximizing a flow of appointments into a business based on a desired appointment volume rather than on a fixed set of physical resources predefined for a time period.

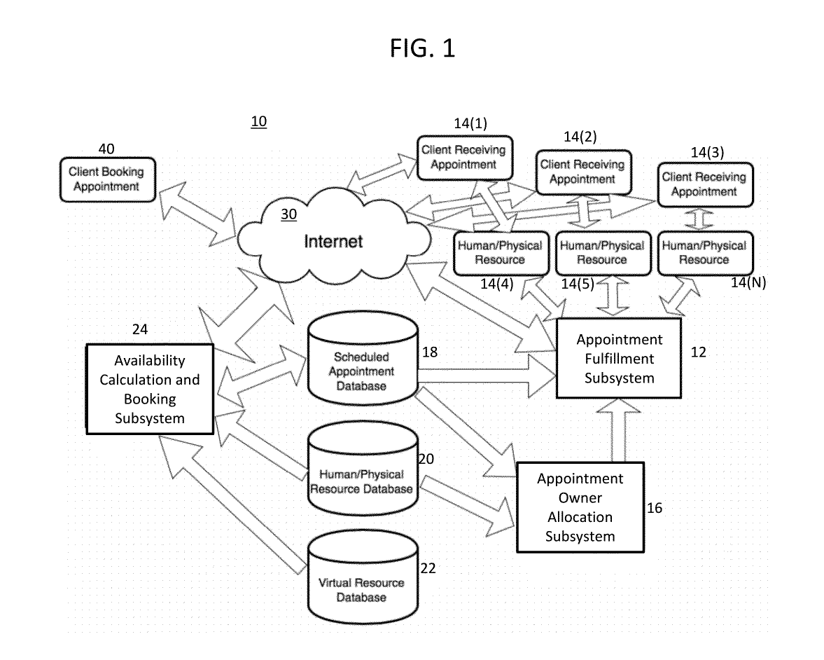

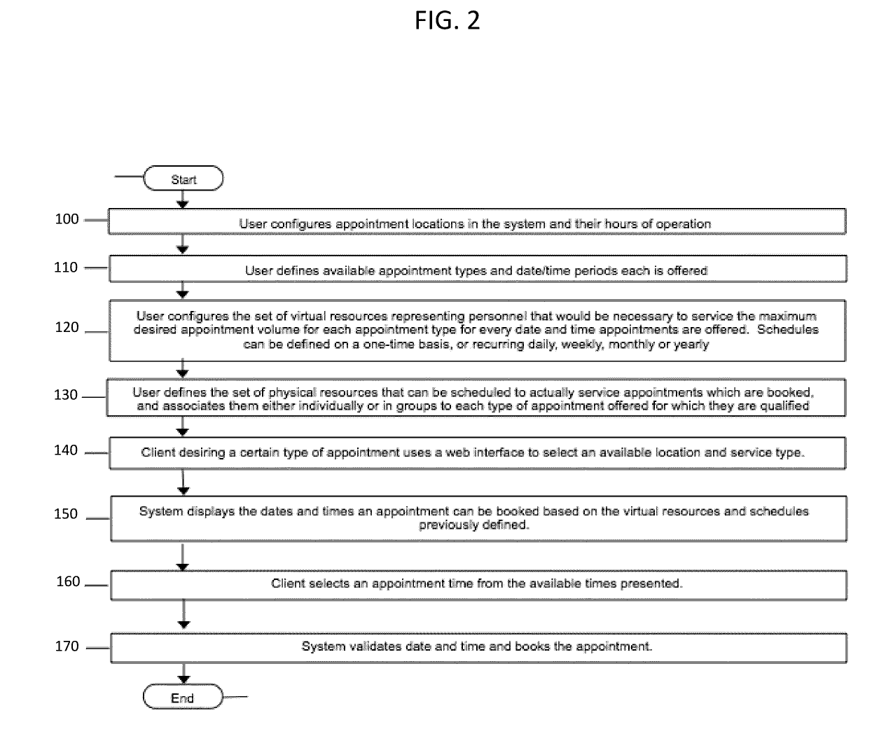

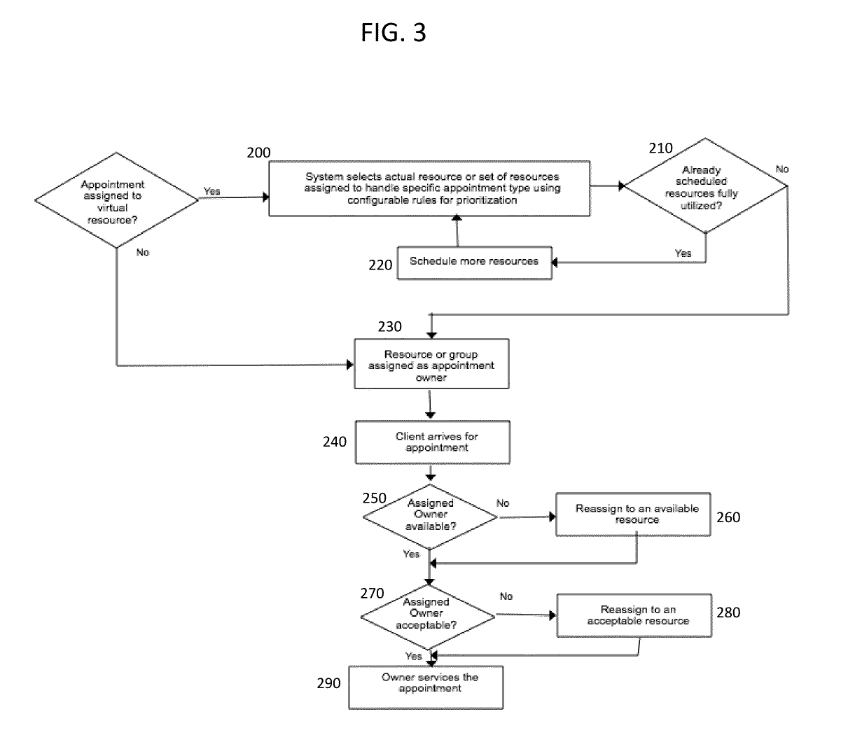

FIG. 1 is a block diagram of a system 10 that includes an appointment fulfillment subsystem 12 connected to a plurality of human/physical resources 14(1)-14(N). There is an appointment owner allocation subsystem 16, a scheduled appointment database 18, a human/physical resource database 20, a virtual resource database 22, and an availability calculation and booking system 24. The various databases shown in FIG. 1 may be separate databases or integrated into a single database. The various entities shown in FIG. 1 may communicate with each other via the Internet 30. The operations of these entities will become apparent when reference is made to FIGS. 2 and 3, as described below. FIG. 1 also shows, at reference numeral 40, a client attempting to book an appointment and a client receiving an appointment with a human/physical resource.

The virtual resources are used to calculate appointment time slot availability, and serve to temporarily reserve physical resources up until the time appointments need to be served. The capacity and characteristics of this virtual set of resources can be based not only on the actual (physical) resources currently employed and available at time of booking, but also on desired expansion targets and other factors such as overbooking and acceptable wait times which might dictate booking a different number of appointments in any given time period than the scheduled physical resource capacity would allow. In other words, the virtual resources represent a volume of physical resources that would need to be served during a given appointment time slot for a given service activity. Thus, the actual number of physical resources that need to be on hand on the day/time of an appointment can be determined very late in the process, rather than at the time of booking, promoting much more efficient resource utilization.

Referring to FIG. 2, a flow chart is now described that illustrates operations according to an example embodiment. Reference is also made to FIG. 1 for purposes of the description of FIG. 2. A “user” in the context of this description is a service provider entity that offers the services for which a “client” may schedule an appointment. As a non-limiting example, the service provider entity may be a doctor's office, an auto maintenance facility, etc. The “client” is a person or entity seeking to schedule an appointment with the service provider entity.

At 100, a user configures appointment locations in the appointment fulfillment system. At 110, the user defines available appointment types and date/time periods when those appointments types are offered.

At 120, the user configures the set of virtual resources representing personnel that are needed to service the maximum desired appointment volume for each appointment type for every date and time the appointments are offered. Schedules can also be defined on a one-time basis, or recurring basis (daily, weekly, monthly, or yearly).

At 130, the user defines the set of physical resources that can be scheduled to service the appointments. These resources are associated individually or in groups to each type of appointment being offered. Examples of physical resources include conference rooms, video projectors, medical testing machines, and automobile service bays.

Information describing the data entered at steps 100-130 is stored by various entities shown in FIG. 1.

At 140, a client desiring a certain type of appointment uses a web-based or other interface to select an available location and service type for an appointment.

At 150, the dates and times for which an appointment can be booked are displayed to the client based on the virtual resources and schedules defined in steps 100-130.

At 160, a client selects an appointment time from the available appointment times presented at 150.

At 170, the system validates the date and time for the selected appointment, and books the appointment for the client.

Reference is now made to FIG. 3. FIG. 3 shows a flow chart for operations performed at the time of a scheduled appointment. At 200, shortly before the time of a scheduled appointment, the system selects the actual resource or set of resources assigned to service/handle a specific appointment type using configurable rules for prioritization. For example, more experienced staff members might be configured to receive higher volumes of appointments than less experienced coworkers who have just recently been trained on how to service the requested type of appointment. At 210, it is determined whether the already scheduled resources for that appointment type are fully utilized and thus not available to service the appointment at the scheduled time. If the answer to operation 210 is “yes”, then the process proceeds to step 220 where more resources are scheduled.

If the answer to operation 210 is “no”, then the process proceeds to step 230. At 230, the resource or group of resources for the appointment is assigned as the appointment owner for the scheduled appointment.

At 240, the client arrives (physically or virtually) for the scheduled appointment.

At 250, it is determined whether the assigned appointment owner is available. If it is determined at 250 that the assigned appointment owner is not available, then at 260 the appointment is reassigned to another available resource (for that type of appointment).

If it is determined that the assigned appointment owner is available at 250, then at 270, it is determined whether the assigned appointment owner is acceptable (to the client). If for some reason the assigned appointment owner is not acceptable to the client, then at 280, an acceptable resource is assigned for the appointment. At 290, the assigned appointment owner services the appointment.

As described above in connection with FIG. 3, the system supports the automatic or manual reassignment of scheduled appointments from virtual resources to physical resources at any time up to the start of the appointment, and allows for further reassignment between physical resources during the course of servicing the appointment.

The following is an example scenario to illustrate how this could work. Customer Charlie schedules an appointment for next Thursday at 9 AM to get his automobile serviced, involving new front brake pads, an oil change and a complete detailing of the vehicle. The scheduling system allows Charlie to book at this time, as it has a maximum of 2 virtual resources defined for brake work Monday-Friday, up to 4 virtual resources for oil changes anytime during the week, and 1 virtual resource defined for detailing. The scheduling system dynamically adjusts the sequence of these services to maximize the number of possible start times presented to the customer where at least one of the necessary virtual resources would be available to perform each of the requested services. Any constraints that may have been defined requiring certain services to be performed before (or after) other specific services would be adhered to when calculating the available start times. All acceptable service sequences are evaluated when determining whether a specific start time is available.

Prior to the day of the appointment, the service manager opens the ‘Manage Appointments’ interface within the scheduling application (the availability and booking subsystem). For any appointments which are not yet ‘owned’ by the actual technicians that will perform the services, the scheduling system selects the resources needed according to their work schedules, the services they are certified to perform, and applicable allocation rules, such as random, round-robin, ranking, or a set of arbitrarily defined characteristics. For example, Charlie's car has disc brakes. Bob is a brake technician working on Thursdays, but the characteristics defined for him show an expertise in drum brakes, which would indicate that he should be allocated last for disc brake work. The system will also alert the service manager if there are not enough people scheduled to service the booked appointments, so that he can call in extra help. This would happen when the automotive service facility choses to schedule fewer people than the number of virtual resources it configured for appointment booking purposes, or when people take time off, etc. This capability can be used, for example, to schedule appointments up to the number that would fill all the service bays, but only call in the number of technicians needed each day to service the actual number of appointments booked, which could be less than the maximum.

The ‘owner’ resource for an appointment can be changed by the service manager if desired. Depending on how permissions are set in the scheduling system, when the service manager edits an appointment owner, the service manager could chose a different owner from a list of the other technicians associated with that type of service, or he could chose from a list of all the technicians working during the time period of the appointment. This would be useful when a customer has a preference for a specific technician, or would like the same technician to perform all of the scheduled services. The service manager can also have the scheduling system recalculate the resource assignments at any time prior to the start of an appointment, to see whether shuffling resources would result in more efficient utilization of those resources.

The tracking of these reassignments for reporting and compensation purposes is also supported. At any given time during the lifecycle of the appointment, it can have one “owner”. The owner can be changed at any time and consists of a single entity that could be a person, room, piece of equipment, vehicle, etc., or could be a predefined group of resources, such as a crew or team or department. Possible owners for any specific type of appointment at any specific business location can be predefined in the system and listed as the potential owners at any given point in the process. Additional logic defining capacity and current availability can be defined and employed when assigning or changing ownership of an appointment.

A user interface and application programming interface (API) are provided for interfacing virtual resources with the schedules, capacities and capabilities necessary to inform the appointment scheduling system's calculation of timeslots available for any predefined appointment type at any predefined location. The logic to apply the definitions of the user interface and API produces the list of start times and durations where appointments can be booked within any date/time range selected, for any combination of appointment types or activities.

A user interface and API are provided that defines the lists of possible owners for any appointment type at any predefined location at any specific period in time. Each possible owner could be a predefined individual resource within the system, or a predefined group of such resources.

A user interface and API are provided to define constraints on the availability of the possible owners at any given moment, to inform the owner selection process.

A user interface and API are provided to present a valid list of potential owners or appointment servicing resources according to predefined rules and lists, at any point in the lifecycle of the appointment, defined as the various steps between initial booking and final resolution.

The appointment scheduling system would provide the following mechanisms to associate potential owners (physical resources) with the available appointment types.

An appointment ‘owner’ can be a single physical resource, a pre-defined group of resources (such as a crew or team), or an ad hoc group of resources created on-the-fly by selecting multiple single resources.

The resources above, either individually or in groups, could be associated with all appointment types, or with categories of appointment types, or with any number of individual appointment types.

Using the automotive service center example from above, one resource group called ‘Detailers’ may be predefined, that consists of Scott, Bill and Sandy, and a service category called ‘Appearance’, which would include the services: Detailing, Wash, Wax. For the Detail service, the group ‘Detailers’ is listed as a potential owner, requiring the whole group to be assigned to the appointment as a unit by selecting ‘Detailers’ as the owner. The individual technicians Scott, Bill, Sandy, Tim and Ralph can be attached to the category ‘Appearance’, which would allow them to be assigned to appointments for any of the service types in the Appearance category, or they can be assigned to one or more of the service types directly, for example, Tim or Ralph do Wax jobs, and Scott or Bill do car washing. However the resources are associated with specific services, whether by being assigned to all service types, categories of service types, or individual service types, their names appear in the list of potential appointment owners on screens where appointment owners are selected.

In scenarios where the scheduling system selects the appointment owner automatically, it would select from the same lists as above, but could apply additional rules to choose among the available resources. For example, resources could be ranked by their experience level, seniority, certifications or personal preferences, which would be characteristics defined for each resource. Each service category or individual service would have a set of rules available to apply in the resource allocation process, and could be configured to apply one or more of these rules in sequence. Examples would be: ‘Select resource by highest rank’, ‘Select resource with the following characteric(s)______’, ‘Select resource by round-robin’, ‘Select resource with fewest appointments this week’, etc. The set of rules most specific would be applied, that is, rules defined for an individual service would override those defined for a category of services.

A user interface and API are also provided to attach an owner or succession of owners to an appointment at any lifecycle stage, with support for both automatic assignment and manual override.

To assign or reassign resource ownership of an appointment through the API, the process would be to call the API method: getAssignableOwnersForAppointmentByConfirmationNumber, which would return the list of resources which could be assigned to that type of appointment. Then, call the setAppointmentOwnersByConfirmationNumber API method thereby passing the appointment confirmation number and new owner (or owner group) resource. Through the scheduling application user interface, a user can edit an appointment, and select the new owner from a drop down list of potential owners. Both the API and user interface would use the associations defined above to populate the lists of potential owners, which might include groups as well as individuals. The scheduling system can be configured to auto-assign owners when an appointment is booked, or at some number of days or hours before the date of the appointment. Both UI and API functions would be provided to assign appointment owners automatically on demand.

Regardless of which method is used to change the appointment owner resource, an audit trail is maintained for reporting purposes showing who owned the appointment during all phases of the appointment service, and which system user changed the ownership and when the change was made.

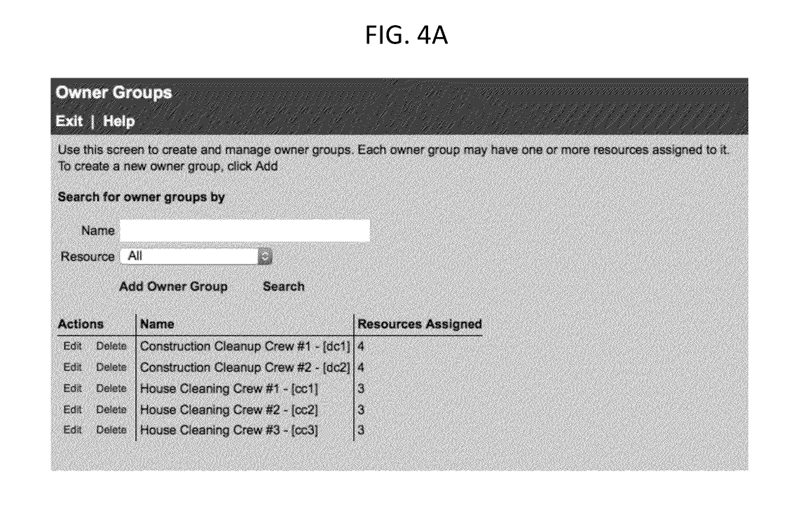

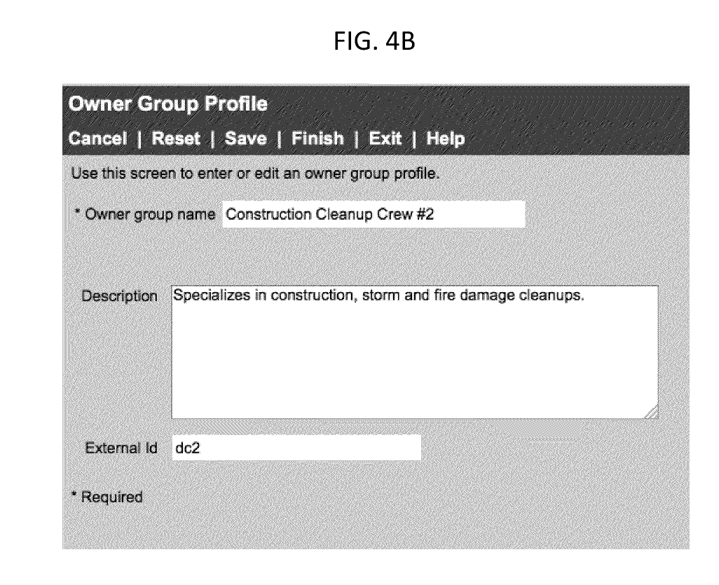

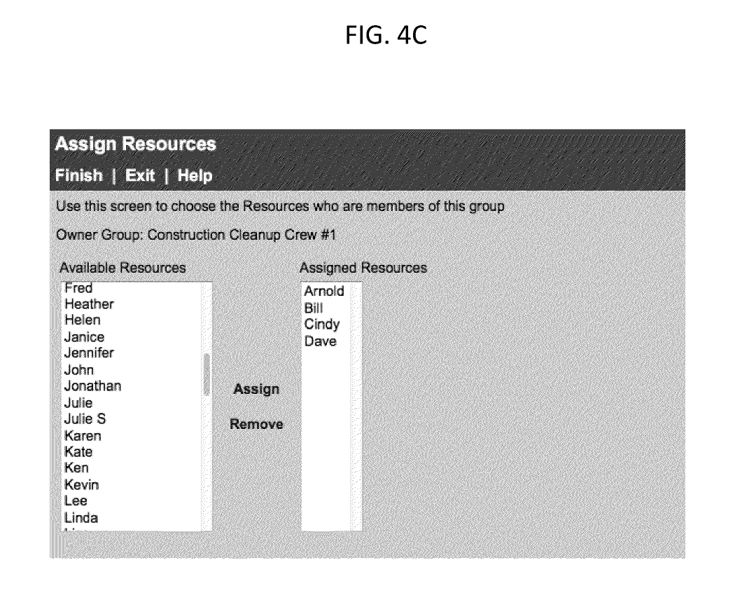

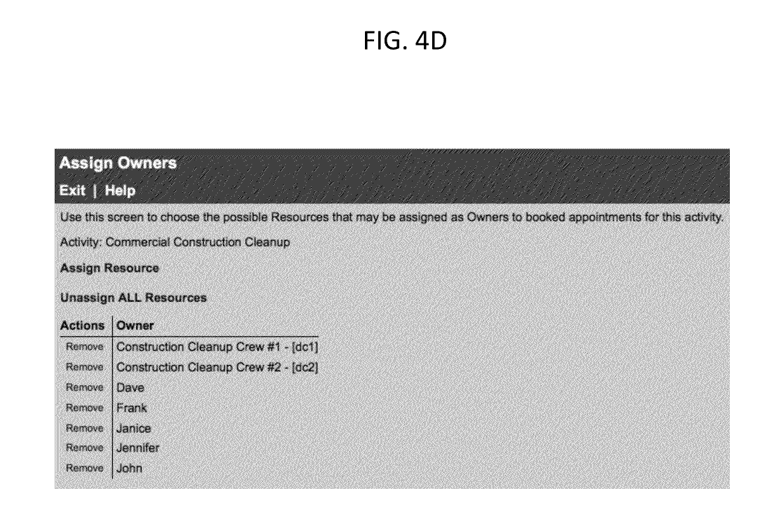

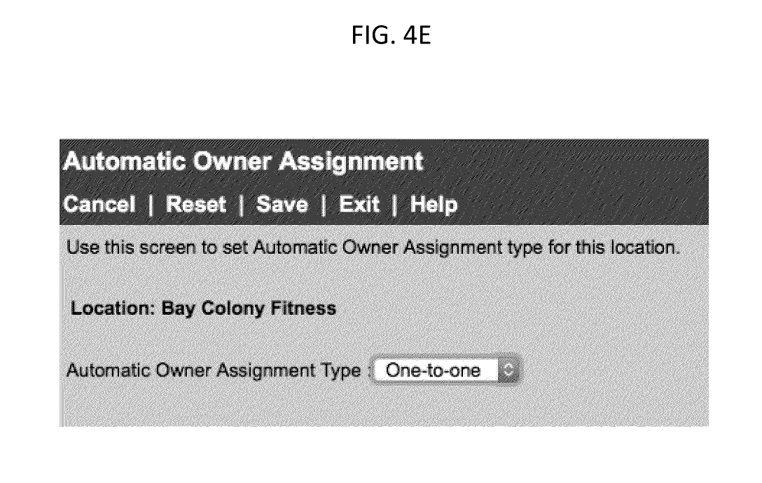

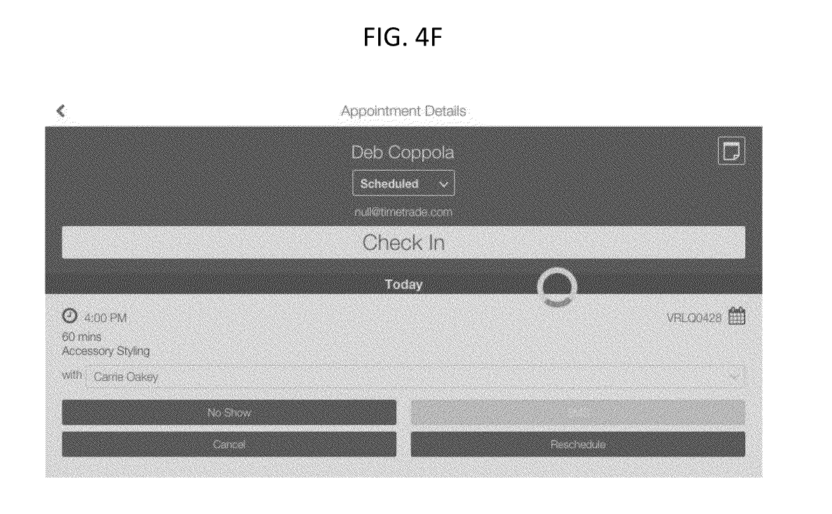

Reference is now made to FIGS. 4A-4F. These figures illustrate examples of user interface screens used for functions related to the operations described above. FIG. 4A illustrate a user interface screen that allows a user to add or edit resource groups which can be assigned to service, i.e., “own” an appointment. Each resource group is given a name and also the number of resources, e.g., persons, assigned to it, as shown in FIG. 4A.

FIG. 4B illustrates a user interface screen that allows a user to add or edit an owner group. More description information can be entered by a user, as shown in FIG. 4B.

FIG. 4C illustrates a user interface screen that allows a user to add physical resources, e.g., persons, to an owner group.

FIG. 4D illustrates a user interface screen for defining the groups and individual resources that could be assigned to service an particular type of appointment. In this example, appointment activity is commercial construction cleanup.

FIG. 4E illustrates a user interface screen for allowing a user to choose the rule to use when an appointment owner is to be chosen automatically by the system.

FIG. 4F illustrates a user interface screen showing how a resource servicing an appointment can be changed manually by selecting a different resource or group from a drop down list at check-in for the appointment.

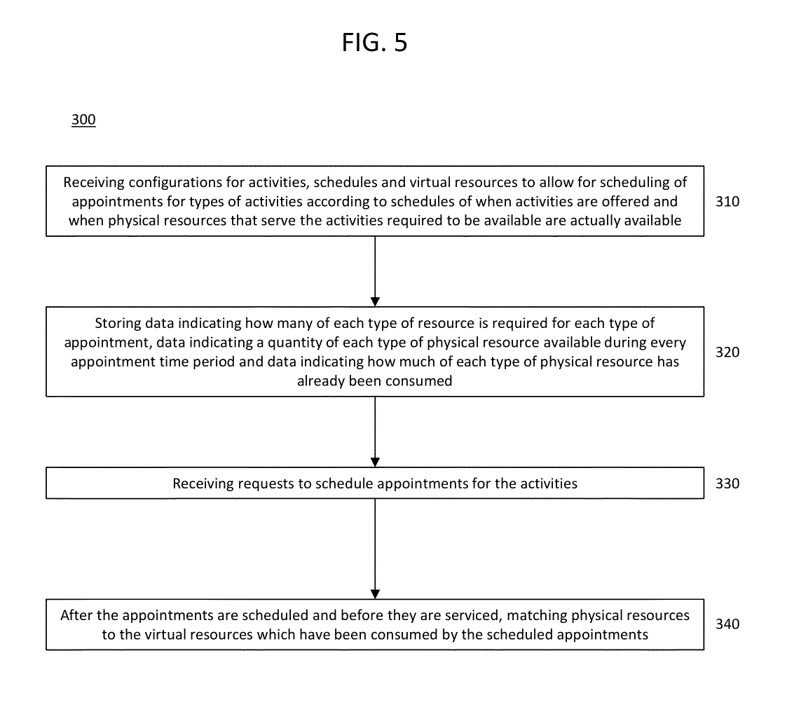

FIG. 5 is a flow chart for a method 300 according to an example embodiment, based on the concepts described above in connection with FIGS. 1-4F. At step 310, configurations are received for activities, schedules and virtual resources to allow for scheduling of appointments for types of activities according to schedules of when activities are offered and when physical resources that serve the activities required to be available are actually available. At 320, data indicating how many of each type of resource is required for each type of appointment, data is stored indicating a quantity of each type of physical resource available during every appointment time period and data indicating how much of each type of physical resource has already been consumed. At 330, requests are received to schedule appointments for the activities. At 340, after the appointments are scheduled and before they are serviced, physical resources are matched to the virtual resources which have been consumed by the scheduled appointments.

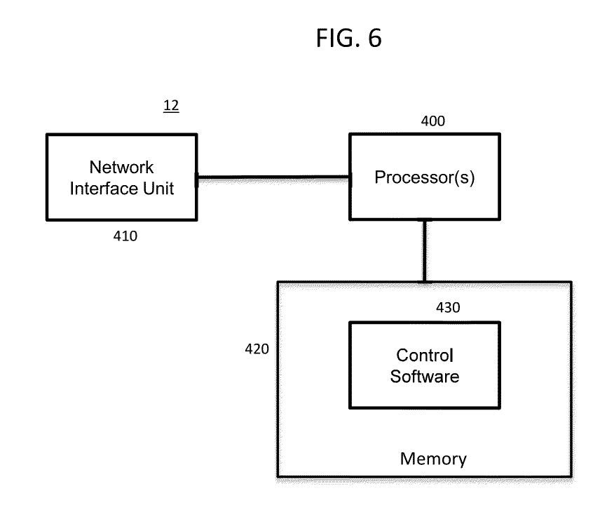

FIG. 6 shows an example block diagram of the appointment fulfillment subsystem 12, as well as the other subsystem entities shown in FIG. 1. The appointment fulfillment subsystem 12 includes one or more processors 400, a network interface unit 410 to enable network communications, and a memory that 420 stores control software 430. The control software 430 includes instructions that, when executed by the one or more processors 400, causes the appointment fulfillment subsystem 12 to perform the operations described and shown herein.

The techniques presented herein may be embodied by software stored in memory 420, such as read only memory (ROM), random access memory (RAM), magnetic disk storage media devices, optical storage media devices, flash memory devices, electrical, optical, or other physical/tangible memory storage devices. In general, the memory 420 may include one or more tangible (non-transitory) computer readable storage media (e.g., a memory device) encoded with software comprising computer executable instructions and when the software is executed (by one or more processors) it is operable to perform the operations described herein.

In summary, the system and method presented herein allows defining configurations of activities, schedules and virtual resources as necessary to allow customers to book appointments for any defined types of activities according to schedules of when locations are open, when certain activities are offered, and when all the resources required to be available are actually available. These resources could be rooms, equipment, supplies, personnel, etc.

The system stores data so that it knows precisely how many of each type of resource are required for each type of appointment, the quantity of each type of resource available during every appointment time period, and how much of each type of resource has already been consumed. However, this information is based on a very specific configuration of virtual resources, which would support the maximum, optimum or ideal flow of appointments into a business or enterprise.

After appointments are booked, and before they are serviced, the system either automatically or with manual overrides, matches actual physical resources to the virtual resources which have been consumed in the scheduling process. This allows attempting to book the optimum or maximum number of appointments, and then scheduling only those physical resources which are needed to service the volume of appointments that were actually booked. Very precise management of resource utilization is possible, and the system supports the definition of scheduling rules adequate to make the process fully automatic.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
receiving configurations for activities, schedules and virtual resources to allow for scheduling of appointments for types of activities according to schedules of when activities are offered and when physical resources that serve the activities required to be available are actually available;
storing data indicating how many of each type of resource is required for each type of appointment, data indicating a quantity of each type of physical resource available during every appointment time period and data indicating how much of each type of physical resource has already been consumed;
receiving requests to schedule appointments for the activities;
storing data for the scheduled appointments; and
after the appointments are scheduled and before they are serviced, matching physical resources to the virtual resources which have been consumed by the scheduled appointments.

2. The method of claim 1, wherein a particular configuration of virtual resources used to determine available times for scheduling of appointments represents a maximum, optimum or ideal flow of appointments for activities to be served by physical resources, and represents a quantity of physical resources which can actually be made available to service the appointments, but which quantity of physical resources may or may not already be scheduled.

3. The method of claim 1, wherein matching physical resources to the virtual resources allows for scheduling only those physical resources which are needed to service a volume of appointments that were actually scheduled.

4. The method of claim 1, wherein the matching is overridden by a user changing assignment of a physical resource that is to service a particular appointment at any time prior the particular appointment being serviced.

5. The method of claim 1, further comprising storing data defining constraints on availability of physical resources at any given point of time.

6. The method of claim 5, further comprising storing information identifying an owner physical resource or succession of owner physical resources to a given appointment or given appointments.

7. The method of claim 6, further comprising automatically reassigning an owner physical resource or manually overriding an assigned owner physical resource for a given appointment or given appointments.

8. An apparatus comprising:
a network interface unit configured to enable communications over a network;
a memory;
a processor coupled to the network interface unit and the memory, wherein the processor is configured to:
receive configurations for activities, schedules and virtual resources to allow for scheduling of appointments for types of activities according to schedules of when activities are offered and when physical resources that serve the activities required to be available are actually available;
store data indicating how many of each type of resource is required for each type of appointment, data indicating a quantity of each type of physical resource available during every appointment time period and data indicating how much of each type of physical resource has already been consumed;
receive requests to schedule appointments for the activities;
store data for the scheduled appointments; and
after the appointments are scheduled and before they are serviced, match physical resources to the virtual resources which have been consumed by the scheduled appointments.

9. The apparatus of claim 8, wherein a particular configuration of virtual resources used to determine available times for scheduling of appointments represents a maximum, optimum or ideal flow of appointments for activities to be served by physical resources, and represents a quantity of physical resources which can actually be made available to service the appointments, but which quantity of physical resources may or may not already be scheduled.

10. The apparatus of claim 8, wherein the processor is configured to match physical resources to the virtual resources allows for scheduling only those physical resources which are needed to service a volume of appointments that were actually scheduled.

11. The apparatus of claim 8, wherein the processor is configured to override the match in response to receiving from a user changes in assignment of a physical resource that is to service a particular appointment at any time prior the particular appointment being serviced.

12. The apparatus of claim 8, wherein the processor is configured to store data defining constraints on availability of physical resources at any given point of time.

13. The apparatus of claim 8, wherein the processor is configured to store information identifying an owner physical resource or succession of owner physical resources to a given appointment or given appointments.

14. The apparatus of claim 8, wherein the processor is configured to automatically reassign an owner physical resource or manually overriding an assigned owner physical resource for a given appointment or given appointments.

15. One or more non-transitory computer readable storage media encoded with instructions that, when executed by a processor, cause the processor to perform operations including:
receiving configurations for activities, schedules and virtual resources to allow for scheduling of appointments for types of activities according to schedules of when activities are offered and when physical resources that serve the activities required to be available are actually available;
storing data indicating how many of each type of resource is required for each type of appointment, data indicating a quantity of each type of physical resource available during every appointment time period and data indicating how much of each type of physical resource has already been consumed;
receiving requests to schedule appointments for the activities;
storing data for the scheduled appointments; and
after the appointments are scheduled and before they are serviced, matching physical resources to the virtual resources which have been consumed by the scheduled appointments.

16. The non-transitory computer readable storage media of claim 15, wherein a particular configuration of virtual resources used to determine available times for scheduling of appointments represents a maximum, optimum or ideal flow of appointments for activities to be served by physical resources, and represents a quantity of physical resources which can actually be made available to service the appointments, but which quantity of physical resources may or may not already be scheduled.

17. The non-transitory computer readable storage media of claim 15, wherein the instructions operable for matching comprises instructions operable for matching physical resources to the virtual resources allows for scheduling only those physical resources which are needed to service a volume of appointments that were actually scheduled.

18. The non-transitory computer readable storage media of claim 15, wherein the matching is overridden by a user changing assignment of a physical resource that is to service a particular appointment at any time prior the particular appointment being serviced.

19. The non-transitory computer readable storage media of claim 15, further including instructions operable for:
storing data defining constraints on availability of physical resources at any given point of time; and
storing information identifying an owner physical resource or succession of owner physical resources to a given appointment or given appointments.

20. The non-transitory computer readable storage media of claim 19, further comprising instructions for automatically reassigning an owner physical resource or manually overriding an assigned owner physical resource for a given appointment or given appointments.
